(19) United States
(12) Patent Application Publication
(10) Pub. No.: US 2006/0027064 A1
(43) Pub. Date: Feb. 9, 2006

(54) Shellfish fork combination and method of use

(76) Inventors: Michael Panik, Las Vegas, NV (US); Rosemary Panik, Las Vegas, NV (US)

Correspondence Address: Galasso & Associates, LP, P. O. Box 26503, Austin, TX, 78755-0503, US

(21) Appl. No.: 11/193,142

(22) Filed: Jul. 29, 2005

Related U.S. Application Data
(60) Provisional application No. 60/598,292, filed on Aug. 3, 2004.

(51) Int. Cl. A47J 43/28

(52) U.S. Cl. 83/13; 30/322

(57) ABSTRACT

A method and apparatus for eating shellfish comprising a fork that contains a handle, a head, a base and a set of tines. One or more of the of the tines includes a cutting blade attached to the inside of one tines. The cutting blade is positioned on one or more of the outer tines. This cutting blade is used to cut through the shell of shellfish when pressure is applied to the cutting blade. Once the shell is cut it is easy to use the tines to remove the meat from the shellfish. Then the fork is used as a typical fork for eating food.

### CROSS REFERENCE TO RELATED APPLICATIONS

This application claims priority to U.S. Provisional Application No. 60/598,292 filed on Aug. 3, 2004.

### FIELD OF THE DISCLOSURE

The shellfish fork combination is a small fork that contains an cutting edge on the inside of a tine that is used to cut through the shell of the shellfish and then the fork is used to remove and eat the meat.

### BACKGROUND

Seafood is a very popular food item not only in the United States but across the world. There are various types of seafood ranging from fish to more exotic creatures of the sea. Some of the creatures have shells and some do not. For example, calamari is not encased in a shell and yet lobster does contain a shell. Therefore, eating seafood can require a wide range of eating utensils. Something as simple as a regular fork serves well for eating fish. Yet, eating shell fish is a more difficult task and requires a completely different set of utensils.

There are a number of utensils on the market for eating seafood. For example, if you are eating escargot, you are typically provided with a small fork capable of removing the escargot from the shell. Alternatively, if you are eating lobster tail, it is usually cut open and cooked allowing the meat to swell outside of the shell. In this instance, you can eat the meat with a regular fork. Shrimp can be served with or without the shell. If it is served with the shell, the easiest way to remove the shell is by using your fingers. While this may be the easiest way to eat shrimp, it is not necessarily the neatest. Other shell fish can be more difficult. For example, if you are attempting to eat crab legs, the legs contain a thick shell that requires cracking. The most popular utensils for eating shell fish like crab legs is a nut cracker and a pick. The nut cracker is used to actually crack the outer shell of the leg and the pick type utensil is used to pull the meat out of the shell. Again, this method of eating shell fish is somewhat messy and is time consuming. However, if you really like the types of shell fish that require effort to eat them, then the time spent removing the meat and the mess involved will not bother you. Alternatively, if you eat in a more upscale restaurant, they will crack the shells for you. While this is a very nice gesture, it does not always work out well. Sometimes, you still have difficulty because they are not cracked well. Wouldn't it be nice to have a utensil that could make this whole process easier by making it neater and less time consuming.

### SUMMARY OF THE DISCLOSURE

In one embodiment an eating utensil for shellfish would comprise a handle.

In another embodiment an eating utensil for shellfish would comprise a head and a base.

In still another embodiment an eating utensil for shellfish would comprise a set of tines.

In yet another embodiment an eating utensil for shellfish would include a cutting blade attached to at least one tine.

In another embodiment the base would be slightly wider than the handle.

In another embodiment an eating utensil for shellfish would comprise at least three tines.

In still another embodiment the cutting blade would be attached on the inside of at least of one tine.

In yet another embodiment the cutting blade would be attached to at least one of the outside tines.

In yet another embodiment the cutting blade would be serrated.

In another embodiment the cutting blade would be capable of cutting through the shell of shellfish.

In another embodiment at least two of the tines would comprise cutting blades.

In still another embodiment the eating utensil would measure approximately five and one-half inches in length.

In yet another embodiment the handle would be smaller in the middle than at the head and the base.

In still another embodiment the tines would measure approximately one and one-half inches in length.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is perspective view of the shellfish fork combination.

FIG. 2 is a cross-sectional view of the shellfish fork combination.

FIG. 3 is a front view of the shellfish fork combination.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

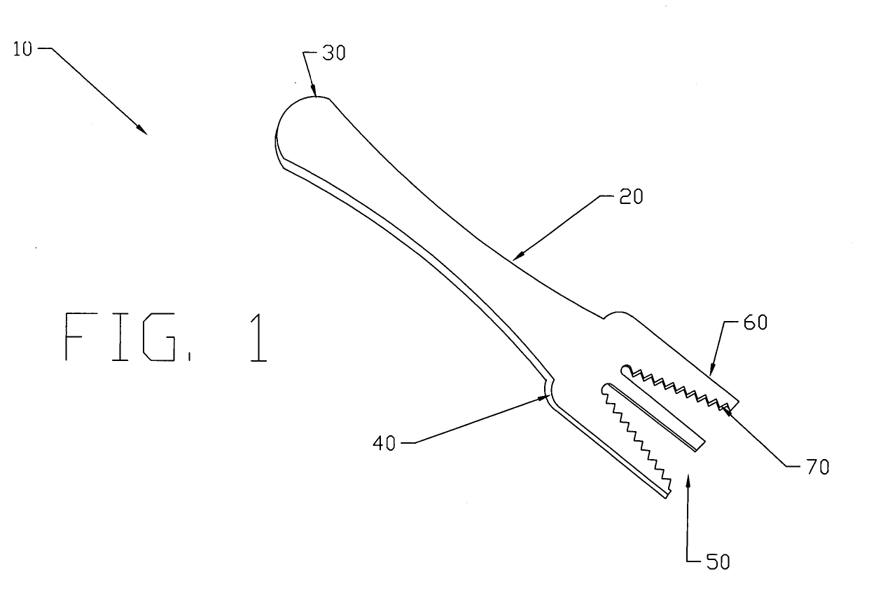

FIG. 1 is a perspective view of the shellfish fork 10 depicting a handle 20, a head 30, a base 40, a set of tines 50, outside tines 60 and cutting blade 70. The handle 20 comprises a head 30 on one end and a base 40 on the opposite end. The end of the handle 20 comprising the base 40 contains a set of tines 50 attached to the base and a cutting blade 70 attached to the outside tines 60. The outside tines 60 can each contain a cutting blade 70 or only one of the outside tines 60 can comprise a cutting blade 70. The cutting blade 70 is included as the inside of the outside tines 60. The cutting blade 70 is designed to cut through shellfish when pressure is applied to the blade. By having a cutting blade 70 on each of the outside tines 60, the need for different configurations based on whether you are right handed or left handed is eliminated.

In order to get to the meat the tines 50 of the shellfish fork 10 would be inserted into the shellfish. You would proceed with by applying pressure to the cutting blade and working it in a sawing type motion across the shell until the shell is cut. Once the shell is cut, you would use the tines 50 of the shellfish fork 10 to remove the meat from the shell. After the meat is removed from the shell you can proceed with eating it by using the shellfish fork 10.

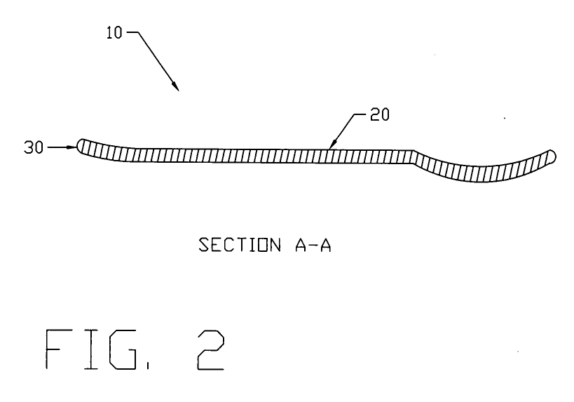

FIG. 2 depicts a cross-sectional view of the shellfish fork 10 and particularly illustrates the angles of the shellfish fork at the head 30 and the base 40.

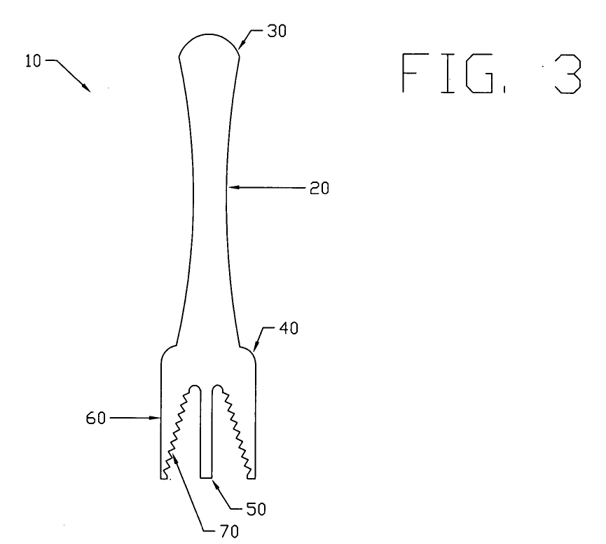

FIG. 3 is a front view of the shellfish fork 10. It further depicts the handle 20, the head 30, the base 40, the tines 50, the outside tines 60 and the cutting blade 70. The handle 20 is smaller in the middle than at the head 30 and the base 40. The thickness of the handle 20 would be the normal thickness of a fork. One or more of the outside tines 60 comprise a cutting blade 70. FIG. 3 shows the cutting blade 70 in a serrated configuration. However, the cutting blade 70 could be just a regular cutting edge. The handle 20, the head 30, the base 40 and the tines 50 combined measure between five and six inches in length. The tines 50 measure between one and two inches in length. FIG. 3 depicts a set on tines 50 wherein there are three tines. Alternative embodiments could include additional tines 50.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. An eating utensil for shellfish comprising:
a handle having a head and a base on opposite ends of the handle;
a set of tines attached the base; and
a cutting blade attached to at least one of the tines.

2. An eating utensil of claim 1, wherein said base is slightly wider than the handle.

3. An eating utensil of claim 1, wherein said set of tines attached to the base comprises three tines.

4. An eating utensil of claim 3, wherein at least one of said tines comprises a cutting blade attached on the inside of said tine.

5. An eating utensil of claim 3, wherein said cutting blade is attached on the inside of one of the outside tines.

6. An eating utensil of claim 5, wherein said cutting blade would be serrated.

7. An eating utensil of claim 1, operable to cut through the shell of shellfish.

8. A method for eating shellfish using a fork having a head and a base attached to opposite ends of a handle, a set of three tines attached to the base and wherein at least one of the tines comprises a cutting blade on the inside of one of the tines, said method comprising the steps of:
positioning the tines in a first position such that the cutting blade engages the shellfish;
moving the cutting blade back and forth across the shellfish to cut a portion of the shellfish;
positioning the tines in a second position to engage fish in the cut portion of the shellfish;
removing fish from the cut portion of the shellfish using the tines; and
eating the fish removed from the cut portion of the shellfish.

9. The method of claim 8, wherein the fork comprises two cutting blades for cutting the shellfish; wherein each of the cutting blades are located on the inside of the two outer tines.

10. The method of claim 8, wherein the cutting blades used for cutting a portion of the shellfish are serrated.

11. The method of claim 8, wherein the fork being used for removing and eating the shellfish measures a five and one-half inches in length.

12. A fork for removing and eating shellfish comprising:
a handle having a head and a base on opposite ends of the handle, wherein said handle is narrower in the middle than at said head and said base;
a set of three tines attached to the base; wherein said tines measure approximately one and one-half inches in length;
a cutting blade attached to one or more inside edges of said tines, wherein said cutting blade is operable to cut through the shell of shellfish.

13. A fork of claim 12, wherein the cutting blade is serrated.

14. A fork of claim 12, wherein said handle, base, head and tines measure approximately five and one-half inches in length.
